(19) United States
(12) Patent Application Publication
(10) Pub. No.: US 2007/0045480 A1
(43) Pub. Date: Mar. 1, 2007

(54) Cables integrated bracket AV system structure

(75) Inventor: Chien-Cheng Yu, Taipei County (TW)

Correspondence Address: BIRCH STEWART KOLASCH & BIRCH, PO BOX 747, FALLS CHURCH, VA, 22040-0747, US

(73) Assignee: HANNSPREE, INC.

(21) Appl. No.: 11/294,401

(22) Filed: Dec. 6, 2005

(30) Foreign Application Priority Data
Aug. 31, 2005 (TW) 094215050

(51) Int. Cl. F16L 3/00

(52) U.S. Cl. 248/51

(57) ABSTRACT

This is a innovative electrical cord structure for audio and video applications that actually succeeds in eliminating the need for those unwieldy and unsightly exterior connection cables. In the future, this should be regarded as an essential part of any home redecoration project, as in the past, a interior designer would be needed to redesign a wall for a hang on TV with rearranging the cables. This solution makes the process much easier, a lot more flexible and significantly more adaptable.

### BACKGROUND TO THE INVENTION

1. Field of the invention

The present invention relates to a cable integrated AV system structure, and more particularly to a wire rearranging AV system that makes it easy to install, integrate and manage a hang on TV's Video and audio digital connection.

2. Description of the Prior Art

In the past, hooking up an AV system entailed attaching a rat's nest of cables. With the advent of the flat panel TV revolution, hang on TV screens and the home theater systems with surround sound are all the rage. It used to be that you bought a television, tied an elastic band around one cord or perhaps sheathed the cord and simply plugged it in.

Now the solution entails costly and time consuming redecoration, even renovation. Another difficulty is that as time goes by, even more money and time must be spent re-renovating, when the layout needs change.

### SUMMARY OF THE INVENTION

Due to the drawbacks of having a tangle of cables connecting various components, designing a system to seamlessly integrate them, conveniently and easily, with maximum adaptability, for both new housing projects as well as renovations.

### BRIEF DESCRIPTION OF THE DRAWINGS

FIG. 1 is a front view of this invention and connected equipment.

FIG. 2 is a rear perspective view of this invention connected to the TV screen.

FIG. 3 is a rear perspective view of this invention.

FIG. 4 is a side view of this invention fixed on the wall.

FIG. 5 is a front perspective view of this invention with the sections separated.

FIG. 6 is an enlarged perspective view of the tongue-and-groove connection of this invention.

FIG. 7 is a perspective view of this invention with wire arrangement.

FIG. 8 is a perspective view of this invention and another wire arrangement.

FIG. 9 is a rear perspective view of the wires arrangement details of this invention.

FIG. 10 is a front view of examples of decorated sections.

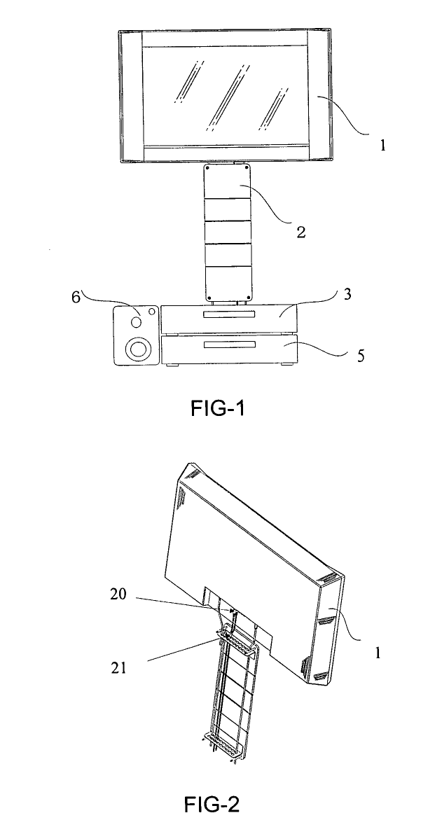

### DESCRIPTION OF THE PREFERRED EMBODIMENT

A connection which is not only convenient and easy to install, but is compatible with the decor and character of the existing space.

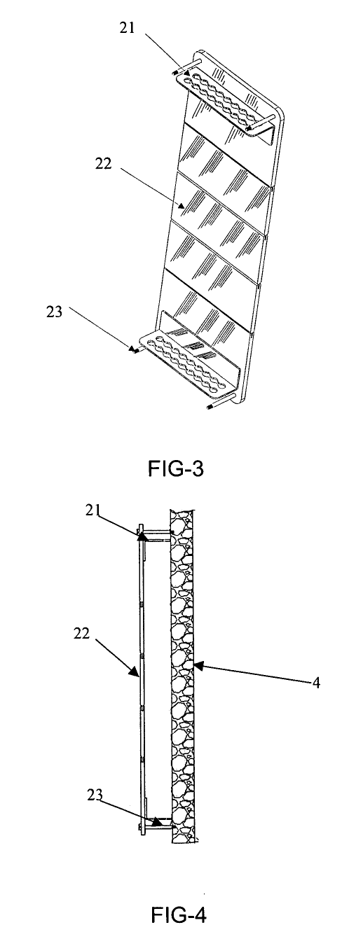

FIG. 3 shows the rear perspective view of a bracket 21, side section 22 and fixed screw 23.

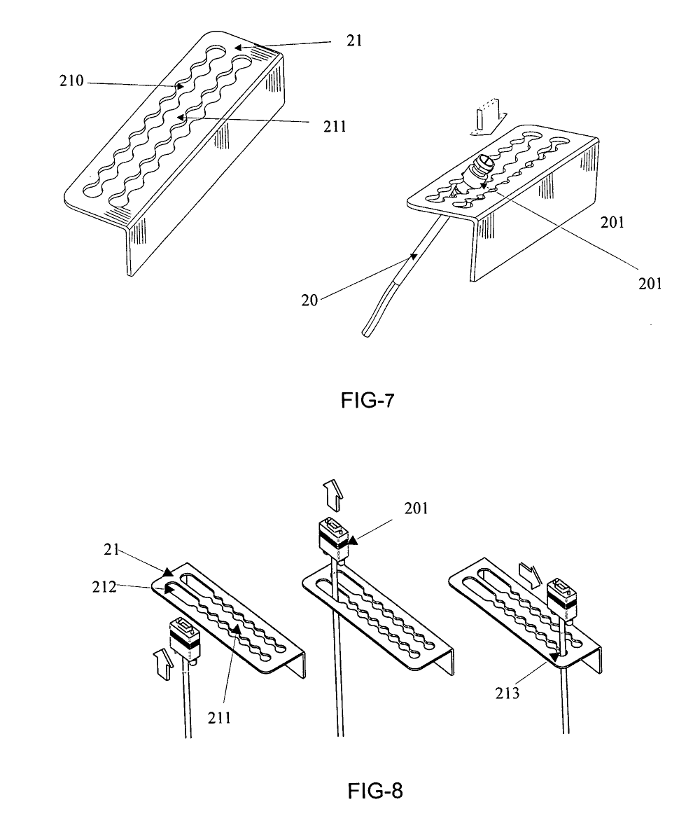

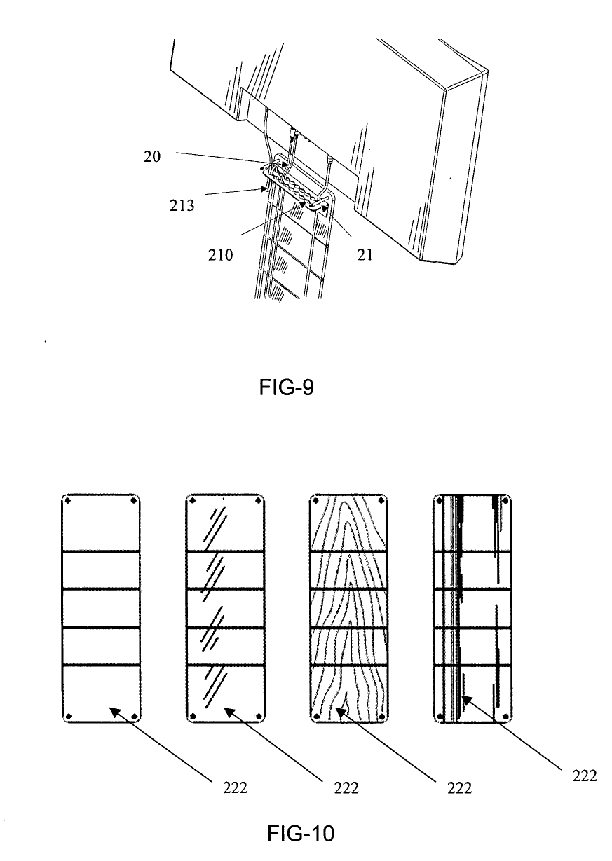

FIG. 7 shows the bracket 21 can be made of elastic material and is L-shaped. A monitor's digital cable 20 feeds through hole 210 in bracket 21.

Because the hole 210 of the integrated bracket 21 is too small for the head 201, the size needs to be increased (see FIG. 8).

The middle section 211 which runs along the bracket 21 between the holes, has the ability to stretch and bend to allow the space of the holes to be increased or widened because the bracket is made of elastic material (see FIG. 7).

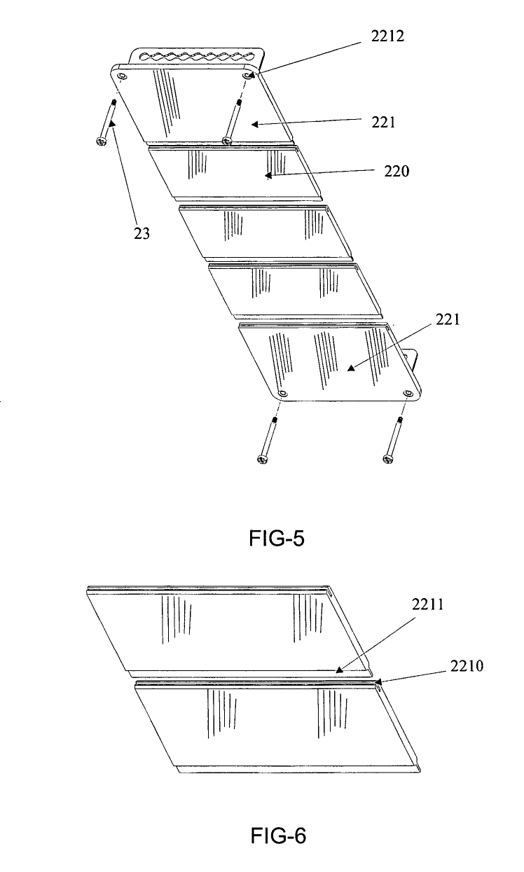

FIG. 8 shows the guiding hole 212 on one side of bracket 21 is made bigger so that the cable head 201 can be fed through bracket 21 from underneath and then moved over to the other side to hole 213 and the excess cable can be folded and pressed through the opposite hole of bracket 21 (see FIG. 5—is a perspective view of the assembly of side section 22 which is formed by the end plate 221 which have bracket 21 fixed on them, and the middle sections 220. The end plate 221 are interchangeable and have a hole 2212 at each corner and can be screwed to the wall 4 by the screw 23 together with side section 22 (see FIG. 4) All parts of side section 22 can be joined together by the tongue 2211 and groove 2210 and the section can be extended by adding more middle sections 220, if required.

FIG. 10 shows the front part of the side section 22 and middle section 220 can be decorated with a wood-grained printed pattern, painted or covered with wall paper, to be compatible with existing space decor. The side section 22 and the bracket 21 can be fixed together by gluing or riveting.

All cables of a hang on TV 1, DVD Player 3, TV box 5, and speakers 6, can be collected and hidden behind this invention (see FIG. 2).

It can also be compatible with the decor of the styles of frontal decoration 222 on side section 22 and middle section 210, to achieve the purpose of organizing the cables efficiently and hiding them and matching the decorations at the same time.

What is claimed is:

1. A cable integrated AV system structure comprises plural side sections, a middle section and a L shaped bracket wherein,
the L shaped bracket made of elastic material has long curved holes for integrated cables;
the side section gluing with the L shaped bracket has holes at the corner and at one edge with tongue-and-groove connector; and
the middle section with tongue-and-groove connector at both edge so as to add the length easily and collect cables in side.

2. The cable integrated AV system structure as in claim 1 wherein the surface of the side section and the middle section can be decorated to simulate wood grain.

3. The cable integrated AV system structure as in claim 1 wherein the surface of the side section and the middle section can be decorated with printed designs.

4. The cable integrated AV system structure as in claim 1 wherein the surface of the side section and the middle section can be decorated by painting it.

5. The cable integrated AV system structure as in claim 1 wherein the surface of the side section and the middle section can be decorated with wallpaper.

6. The cable integrated AV system structure of claim 1 wherein additional sections can be added to the middle section as required.
